(19) United States
(12) Patent Application Publication
(10) Pub. No.: US 2025/0310078 A1
(43) Pub. Date: Oct. 2, 2025

(54) METHODS AND SYSTEMS FOR HOMOMORPHIC ENCRYPTION OF RATIONAL NUMBERS USING A BFV HOMOMORPHIC ENCRYPTION SCHEME MODIFIED WITH A LAURENT POLYNOMIAL RING

(71) Applicant: Algemetric, Inc., Colorado Springs, CO (US)

(72) Inventors: Gaetan Delavignette, Colorado Springs, CO (US); Luke E. Harmon, Colorado Springs, CO (US)

(73) Assignee: Algemetric, Inc., Colorado Springs, CO (US)

(21) Appl. No.: 19/092,947

(22) Filed: Mar. 27, 2025

Related U.S. Application Data
(60) Provisional application No. 63/570,600, filed on Mar. 27, 2024.

(51) Int. Cl. H04L 9/00

(52) U.S. Cl. CPC H04L 9/008

(57) ABSTRACT

Disclosed are methods and systems to provide homomorphic compatible encryption of rational numbers using a modified Brakerski, Fan, and Vercauteren (BFV) homomorphic encryption scheme where classical polynomial rings in BFV homomorphic encryption are replaced by Laurent polynomial rings. This allows for encryption/decryption of rational numbers without the need to encode and decode the numbers before encryption and after decryption, respectively. Encoded rational numbers are provided to the modified BFV system on a source device that may optionally deliver the encrypted ciphertext to an intermediary device for performance of homomorphic algebra operations, and, the resultant or original ciphertext is delivered to a destination device for decryption of the ciphertext into a rational number.

### CROSS-REFERENCE TO RELATED APPLICATIONS

This application is based upon and claims the benefit of U.S. provisional application Ser. No. 63/570,600, filed Mar. 27, 2024, entitled “HERatio: Homomorphic Encryption of Rationals Using Laurent Polynomials,” all of which is also specifically incorporated herein by reference for all that it discloses and teaches.

### BACKGROUND OF THE INVENTION

The advancement of science is possible when knowledge is shared and information is exchanged in a seamless manner. In a world where many businesses rely on information as their main assets, analysis over data is a crucial competitive advantage. Consequently, the amount of data processed and stored will continue to increase, creating a demand for virtualized services. To this end, some applications can be provided as cloud computing resources including Internet of Things (IoT), machine learning, virtual reality (VR) and blockchain. As a result, concerns about custody and privacy of data are on the rise.

Modern concealment/encryption employs mathematical techniques that manipulate positive integers or binary bits. Asymmetric concealment/encryption, such as RSA (Rivest-Shamir-Adleman), relies on number theoretic one-way functions that are predictably difficult to factor and can be made more difficult with an ever-increasing size of the encryption keys. Symmetric encryption, such as DES (Data Encryption Standard) and AES (Advanced Encryption Standard), uses bit manipulations within registers to shuffle the concealed text/cryptotext/ciphertext to increase “diffusion” as well as register-based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext/ciphertext) data, thus, making it difficult to discover the encryption key of the concealment/encryption process by spreading the influence of each piece of the unencrypted (plain) data across several pieces of the concealed/encrypted (cryptotext) data. Consequently, an encryption system that has a high degree of diffusion will typically change several characters of the concealed/encrypted (cryptotext/ciphertext) data for the change of a single character in the unencrypted (plain) data making it difficult for an attacker to identify changes in the unencrypted (plain) data. Confusion is generally thought of as obscuring the relationship between the unencrypted (plain) data and the concealed/encrypted (cryptotext) data. Accordingly, a concealment/encryption system that has a high degree of confusion would entail a process that drastically changes the unencrypted (plain) data into the concealed/encrypted (cryptotext/ciphertext) data in a way that, even when an attacker knows the operation of the concealment/encryption method (such as the public standards of RSA, DES, and/or AES), it is still difficult to deduce the encryption key.

Homomorphic Encryption is a form of encryption that allows computations to be carried out on concealed ciphertext as it is concealed/encrypted without decrypting the ciphertext that generates a concealed/encrypted result which, when decrypted, matches the result of operations performed on the unencrypted plaintext.

The word homomorphism comes from the ancient Greek language: óμóζ (homos) meaning “same” and μoρφ\acute{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set.

For instance, a map ƒ between sets A and B is a homomorphism of A into B if

$$f ( {a}_{1} op {a}_{2} ) = f ( {a}_{1} ) op f ( {a}_{2} ) \vert {a}_{1} , {a}_{2} ∈ A$$

where “op” is the respective group operation defining the relationship between A and B.

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

### SUMMARY OF THE INVENTION

An embodiment of the present invention may comprise a method for Homomorphic Encryption (HE) of Rational data (HERatio) built upon Brakerski, Fan, and Vercauteren (BFV) homomorphic encryption for homomorphic encrypted data transmission between a source computing device and a destination computing device, the method comprising: encrypting by the source computing device at least one rational number into a corresponding at least one ciphertext using an instance of a modified BFV homomorphic encryption operating on the source computing device wherein the modified BFV homomorphic encryption is modified such that classical polynomial rings in BFV homomorphic encryption are replaced by Laurent polynomial rings; sending by the source computing device the at least one ciphertext to the destination computing device; decrypting by the destination computing device the at least one ciphertext into the at least one rational number using an instance of the modified BFV homomorphic encryption having the classical polynomial rings in the BFV homomorphic encryption replaced by the Laurent polynomial rings operating on the destination computing device.

An embodiment of the present invention may further comprise a HERatio system that provides Homomorphic Encryption (HE) of Rational data that is built upon Brakerski, Fan, and Vercauteren (BFV) homomorphic encryption for homomorphic encrypted data transmission between a source computing device and a destination computing device, the HERatio system comprising: the source computing device, wherein the source device further comprises: a HERatio encryption subsystem that encrypts at least one rational number into a corresponding at least one ciphertext using a modified BFV homomorphic encryption scheme wherein the modified BFV homomorphic encryption is modified such that classical polynomial rings in BFV homomorphic encryption are replaced by Laurent polynomial rings; and a ciphertext send subsystem that sends the at least one ciphertext to the destination computing device; and the destination computing device, wherein the destination computing device further comprises: a HERatio decryption subsystem that decrypts the at least one ciphertext into the at least one rational number using the modified BFV homomorphic encryption that has the classical polynomial rings in the BFV homomorphic encryption scheme replaced by the Laurent polynomial rings.

### BRIEF DESCRIPTION OF THE DRAWINGS

In the drawings,

FIG. 1 is a block diagram of the hardware implementation for an embodiment.

FIG. 2 is a flow chart of operations for an embodiment.

### DETAILED DESCRIPTION OF THE EMBODIMENTS

Presented herein is HERatio, a homomorphic encryption scheme that builds on the scheme of Brakerski, Fan and Vercauteren (BFV). An embodiment naturally accepts Laurent polynomials as inputs, allowing it to work with rationals via their bounded base-b expansions. This eliminates the need for a specialized encoder and streamlines encryption, while maintaining comparable efficiency to BFV. To achieve this, we introduce a new variant of the Polynomial Learning With Errors (PLWE) problem which employs Laurent polynomials instead of the usual “classic” polynomials, and provide a reduction to the PLWE problem.

### 1 INTRODUCTION

In 1978, a year after the eponymous RSA cryptosystem was developed by Rivest, Shamir, and Adleman, the idea of “privacy homomorphisms” was proposed. This privacy homomorphism was, in part, based on the observation that the product of two RSA-encrypted secrets would decrypt to the product of the two secrets. From there the idea of an encryption scheme that allows for various operations to be performed on encrypted data gained traction and became the focus of many dedicated researchers. Such a scheme that permits both addition and multiplication on encrypted data is called a Homomorphic Encryption (HE) scheme. An HE scheme allows entities to out-source storage of and computations on sensitive information. Until 2009, all known HE schemes could only handle a bounded number of additions and multiplications before decryption was required. Several early schemes supported an unlimited number of one operation, but none supported both. This changed when a so-called Fully Homomorphic Encryption (FHE) scheme that could handle an unlimited number of additions and multiplications without decryption was published in 2009.

Presently, a large portion of the research and development in homomorphic encryption is focused on the usability of HE schemes in real-world applications. To this end, many researchers are working on efficient implementations with suitable software and/or hardware support and developing practically-usable libraries that can support tasks such as machine learning and business analytics.

Most of the cutting-edge HE schemes are defined to encrypt integers (modulo integers) or polynomials whose coefficients are modulo integers. However, many real-world applications use real numbers or fixed/floating-point rational numbers instead of integers. Typically, this is handled by using an encoder that converts the given inputs to a suitable form for homomorphic encryption. Of course, this encoder must be homomorphic with respect to both addition and multiplication, and also injective. It is also important for this encoder to be efficient and not hinder the efficiency of the associated HE scheme.

The majority of modern HE schemes are based on the Ring Learning with Errors (RLWE) hard problem or one of its variants. In such schemes the plaintext space is the ring Rₜ= [symbol] ₜ[x]/Φₘ [symbol] ₜ[x] where Φₘ(x) is the m-th cyclotomic polynomial and [symbol] ₜ is the ring of integers modulo t. In practice, the elements of Rₜ are simply viewed as polynomials with bounded degree. Encoding integers to elements of Rₜ can be straightforward, a common way being to use the base t representation of the integer. Encoding rational numbers, which are normally represented as fixed-point numbers, is more complex. One approach scales the fixed-point numbers to integers and then encodes them to polynomials using an appropriate base. Another simply treats them as fractional numbers. It has been demonstrated that these two representations are isomorphic, and that the latter approach, although avoiding the overhead of bookkeeping with homomorphic ciphertexts, is difficult to analyze.

Most of these encodings have the same problem, namely, the modulus t must be sufficiently large for the encoding to work correctly. This, in turn, creates faster noise growth and requires the HE scheme to use larger parameters, which hinders the scheme's efficiency. A few clever solutions have been devised to remedy this, the first one borrows a mathematical technique from another work and combines it with the HE scheme introduced by Fan and Vercauteren and another introduced by Brakerski (BFV). The main idea of the solution is to replace the modulus t by the polynomial x−b for a positive integer b, and then use as the plaintext the quotient ring [symbol] /(bⁿ+1) [symbol] . The second solution, encodes rationals by computing their base-b expansion, replacing b by an unknown x, and then mapping the resulting Laurent polynomial to an appropriate “classic” polynomial using a novel ring homomorphism.

Introduced herein is a homomorphic encryption scheme for rationals. HERatio (Homomorphic Encryption for Rationals) naturally accepts Laurent polynomials corresponding to bounded base-b expansions of rational numbers without the need of a specialized encoder. While enjoying efficiency comparable to BFV, it is more mathematically streamlined than prior art, and also mitigates the difficulty in choosing parameters to make sure a rational encoding “plays well” with the underlying HE scheme. HERatio may be viewed as a variant of the well-known Brakerski/Fan-Vercauteren (BFV) scheme, and is obtained (among other modifications) by replacing the rings of “classic” polynomials in BFV by rings of Laurent polynomials. Of course, it must be shown that these changes do not disturb the security of BFV. This is done by introducing a new hardness assumption using Laurent polynomials that can be reduced to the hardness assumption used by BFV. In particular, an embodiment introduces a new (decisional) version of the Polynomial Learning With Errors (PLWE) problem which uses the Laurent polynomial ring [symbol] _{q}[x^{±1}]/ƒ [symbol] _{q}[x^{±1}] instead of [symbol] _{q}[x]/ƒ [symbol] _{q}[x] as in the decisional-PLWE problem. An embodiment then uses the novel encoding homomorphism to show that the new problem based on Laurent polynomials is at least as hard as the decisional-PLWE problem under certain conditions, and that modifying the BFV scheme to use the new problem results in comparable efficiency.

### 2 NOTATIONS AND FOUNDATIONS

### 2.1 Notations

[symbol] will denote the ring of integers, and [symbol] ₐ will denote the ring of integers modulo a∈ [symbol] . For a∈ [symbol] , we will identify the elements of [symbol] ₐ with integer representatives [−└(a−1)/2┘, ┌(a−1)/2]┐∩ [symbol] . For a ring R, R[x] will denote the ring of polynomials in x with coefficients from R, and R[x^{±1}] will denote the ring of Laurent polynomials. For r∈R, R/rR will denote the quotient ring whose elements are the cosets (in R) of the ideal rR. Quotient rings will only arise when R is a ring of (Laurent) polynomials. For non-negative integers [symbol] , k we use

$${ℤ [ {x}^{\pm 1} ]}_{- ℓ}^{k} ( resp . {{ℤ}_{a} [ {x}^{\pm 1} ]}_{- ℓ}^{k} )$$

to denote the subset of [symbol] [x^{±1}] (resp. [symbol] ₐ[x^{±1}]) with exponents ranging from − [symbol] to k. For n a power of 2, Φ₂ₙ denotes the 2n^{th} cyclotomic polynomial xⁿ+1. For a distribution x over a set A and a function ƒ: A→A′, we denote by ƒ(x) the distribution over A′ induced by x and ƒ, x←x will mean that x is chosen from A according to the distribution x.

### 2.2 Laurent Polynomials

Naïvely, one thinks of Laurent polynomials in an unknown x as polynomials in which there can be negative integer powers of x. E.g. 2x⁻³-5x⁻¹+1+x² is a Laurent polynomial with integer coefficients. In general, the ring of Laurent polynomials in x with coefficients from the ring R may be defined as

$$R [ {x}^{\pm 1} ] := \{ {\sum }_{i ∈ ℤ} {a}_{i} {x}^{i} \vert {a}_{i} ∈ R , and only finitely many {a}_{i} are nonzero \}$$

An important property of R[x^{±1}] that will be used later (e.g. in the proof of Proposition 1) is that the ring of “classic” polynomials R[x] is a subring of the ring of Laurent polynomials R[x^{±1}] for all rings R. Example 2 and Example 3 show how we use Laurent polynomials for our hardness-assumption reduction and base-b encoding of rationals, respectively.

2.3 Polynomial Learning with Errors

We first recall the Polynomial Learning With Errors (PLWE) problem, on which the well-known Brakerski/Fan-Vercauteren (BFV) scheme is based.

### Definition 1 (Decisional PLWE)

For all K∈ [symbol] , let ƒ(x)=ƒ_{κ}(x) be a polynomial of degree n=n(κ), and let q=q(κ) be a prime integer. Let R= [symbol] [x]/ƒ [symbol] [x], R_{q}=R/qR, and x denote a distribution over R. The decisional-PL WE problem PLWE_{ƒ,q,X} states that for any [symbol] =poly(κ) it holds that

[symbol]

is computationally indistinguishable from

[symbol]

where s is sampled from the distribution x, the aⁱ are uniform in R_{q}, the error polynomials e; are sampled from x, and the ring elements uᵢ are uniformly random over R_{q}.

It is also worth noting that for noise growth and performance reasons, it is possible to use a variant in which the coefficients of the secret key are uniformly selected from {−1, 0, 1}. This was originally suggested as an optimization. It was also shown in elsewhere that certain small-secret PLWE variants are as hard as those with s←x if the degree is sufficiently increased, even though more attacks can be used in this scenario.

### 2.4 The BFV Scheme

Since the scheme of an embodiment is a variant of the Brakerski/Fan-Vercauteren (BFV) scheme, we briefly recall some of the relevant details.

For its security, BFV relies on the hardness of the decisional-PLWE problem with ƒ(x)=Φ₂ₙ(x), and x a discrete gaussian distribution on R with small standard deviation, normally chosen to be around 3.2 in practice.

The following algorithms are the basis of a common variant of the BFV scheme using the ternary distribution for s and u. Let Δ=└q/t┘ such that q=Δt+rₜ(q) for some rₜ(q)<t. It should be assumed that t<<q, which is required for most useful parameters.
BFV.SecretKeyGen: Sample s∈R with coefficients uniformly distributed in {−1,0,1}.
Output

$$sk = s$$

BFV.PublicKeyGen(sk): Let s=sk. Sample a←R_{q}, and e←x.
Output

$$pk = ( {[ - ( as + e ) ]}_{q} , a ) ∈ {R}_{q} \times {R}_{q}$$

BFV.Enc(pk, m∈Rₜ): To encrypt a message m∈Rₜ. Let pk=(p₀,p₁).
Sample u∈R with coefficients uniform in {−1, 0, 1}, and e₀, e₁←x.
Output

$$ct = ( {[ Δ m + {p}_{0} u + {e}_{0} ]}_{q} , {[ {p}_{1} u + {e}_{1} ]}_{q} ) ∈ {R}_{q} \times {R}_{q}$$

BFV.Dec(sk, ct∈R_{q}×R_{q}). Let s=sk and ct=(c₀, c₁).
Output

$${m}^{′} ( X ) = {[ ⌊ {\frac{t}{q} [ {c}_{0} + {c}_{1} s ]}_{q} ⌋ ]}_{t} ∈ {R}_{t}$$

### 3 LWE WITH LAURENT POLYNOMIALS

Let ƒ∈ [symbol] [x] and k, [symbol] be non-negative integers such that k+ [symbol] +1=deg ƒ. Here we introduce a new (decisional) version of the LWE problem which uses the ring [symbol] [x^{±1}]/ƒ [symbol] [x^{±1}] with representatives

$${ℤ [ {x}^{\pm 1} ]}_{- ℓ}^{k}$$

instead of [symbol] [x]/ƒ [symbol] [x] with representatives

$${ℤ [ {x}^{\pm 1} ]}_{0}^{𝓀 + ℓ} = \{ p ( x ) ∈ ℤ [ x ] \vert deg p < deg f \}$$

(as in the decisional-PLWE problem). We then show that the new problem based on Laurent polynomials is at least as hard as the decisional-PLWE problem under certain conditions. Throughout this section, [symbol] = [symbol] [x] and [symbol] = [symbol] [x^{±1}]. Also, for a∈ [symbol] , [symbol] ₐ= [symbol] /a [symbol] and [symbol] ₐ= [symbol] /a [symbol] .
3.1 from “Classic” Polynomials to Laurent Polynomials

Before introducing the new problem, we build the tools required to show that the new problem is at least as hard as PLWE_{f,q,x} in certain cases. We first show that the rings [symbol] [x]/ƒ [symbol] [x] and [symbol] [x^{±1}]/ƒ [symbol] [x^{±1}] are isomorphic for certain polynomials f. The isomorphism ends up simply being the map p(x)+ƒ [symbol] [x]= [symbol] p(x)+ƒ [symbol] [x^{±1}], which means that if we are to use proper Laurent polynomials as representatives, we need a way to switch representatives in the ring [symbol] [x^{±1}]/ƒ [symbol] [x^{±1}].

Recall the following classic theorem from elementary algebra.

Lemma 1 (Second Isomorphism Theorem). Let R be a ring, S a subring of R, and I an ideal of R. Then S+I is a subring of R, S∩I, and

φ: (S+1)/I→S/(S∩I) defined by x+I [symbol] x+S∩I

is a ring isomorphism.

Proposition 1. Let ƒ∈ [symbol] with ƒ(0)∈ [symbol] a unit, L= [symbol] /ƒ [symbol] , and R= [symbol] /ƒ [symbol] . Then there is a ring isomorphism L≅R.

Proof. [symbol] is a subring of [symbol] , and ƒ [symbol] is an ideal of [symbol] . So by Lemma 1, ( [symbol] +ƒ [symbol] )/ƒ [symbol] ≅ [symbol] /( [symbol] ∩ƒ [symbol] ). We claim that [symbol] +ƒ [symbol] = [symbol] . That the sum is contained in [symbol] is easy. For the other containment, it suffices to show that x^{k}∈ [symbol] +ƒ [symbol] for all k∈ [symbol] . That this holds for k≥0 is immediate from the definition of [symbol] . To see that this also holds for negative powers, first observe that x⁻¹(ƒ(x)−ƒ(0))∈ [symbol] . Now, ƒ(0)x⁻¹=x⁻¹(ƒ(0)−ƒ(x))+x⁻¹ƒ(x)∈ [symbol] +ƒ [symbol] . Whence x⁻¹=ƒ(0)⁻¹(ƒ(0)x⁻¹)∈ [symbol] +ƒ [symbol] , since ƒ(0) is a unit. An easy induction then shows that x^{k}∈ [symbol] +ƒ [symbol] for all k<0. Clearly [symbol] ∩ƒ [symbol] =ƒ [symbol] , whence [symbol] /ƒ [symbol] = [symbol] /ƒ [symbol] . Equivalently, [symbol] ≅ [symbol] , as desired.

Remark 1. The same result holds if we replace everywhere [symbol] by [symbol] ₐ, a∈ [symbol] , but with the slightly better condition that ƒ(0) is invertible modulo a.

As mentioned at the beginning of this subsection, we need to map representatives in the set

$${{ℤ}_{a} [ {x}^{\pm 1} ]}_{- ℓ}^{k}$$

to their equivalents in

$${{ℤ}_{a} [ {x}^{\pm 1} ]}_{0}^{k + ℓ}$$

and vice versa. This can be done efficiently (using only matrix multiplications and inversions) using a ring homomorphism. We pause briefly to describe this homomorphism and give an example.

Let ƒ(x)∈ [symbol] ₐ such that ƒ(0)∈ [symbol] ₐ is a unit. The ring homomorphism [symbol] ₐ→Rₐ= [symbol] ₐ/ƒ [symbol] ₐ is induced by the correspondences

$$x ↦ x and {x}^{- 1} ↦ - g ( x ) {f ( 0 )}^{- 1} , where f ( x ) = g ( x ) x + f ( 0 ) . \qquad ( 1 )$$

Let [symbol] , k be non-negative integers satisfying deg ƒ=k+ [symbol] +1. The ring homomorphism in Equation (1) induces a free [symbol] ₐ-module isomorphism

$${η}_{f , ( - ℓ , k )} : {{ℤ}_{a} [ {x}^{\pm 1} ]}_{- ℓ}^{k} \to {{ℤ}_{q} [ {x}^{\pm 1} ]}_{0}^{k + ℓ} .$$

As a free module isomorphism, [symbol] can be computed efficiently using a matrix multiplication. If the polynomial ƒ and integers k, [symbol] are clear from context, we will simply write n.

### Example 1. Consider ƒ(x)=1+x+x²−x³+x⁴∈₃[x]. ƒ(0)∈₃ is a unit and ƒ(x)=x(1+x−x²+x³)+1, so η_{ƒ} is defined by

$$x ↦ x and {x}^{- 1} ↦ - 1 - x + {x}^{2} - {x}^{3}$$

Taking [symbol] =3 makes the domain of

$${η}_{f} {{ℤ}_{3} [ {x}^{\pm 1} ]}_{- 3}^{0} = \{ a {x}^{- 3} + b {x}^{- 2} + {cx}^{- 1} + d \vert a , b , c , d ∈ {ℤ}_{3} \} ,$$

and the range

$${{ℤ}_{3} [ {x}^{\pm 1} ]}_{0}^{3} = \{ a + b x + c {x}^{2} + d {x}^{3} \vert a , b , c , d ∈ \} .$$

The domain and range being free [symbol] ₃-modules allows us to represent η_{ƒ} (encoding map) and its inverse (decoding map) using matrices:

$$encode matrix = [ \begin{matrix}- 1 & 0 & - 1 & 1 \\ 1 & - 1 & - 1 & 0 \\ 1 & 1 & 1 & 0 \\ 0 & 1 & - 1 & 0\end{matrix} ] , decode matrix = [ \begin{matrix}0 & - 1 & - 1 & 0 \\ 0 & - 1 & 1 & - 1 \\ 0 & - 1 & 1 & 1 \\ 1 & 1 & 0 & 1\end{matrix} ] .$$

It is worth mentioning that when ƒ(x)=Φ₂ₙ(x)=xⁿ+1 (a common choice for PLWE) η_{ƒ} can be computed without any matrix multiplications. In particular, η_{ƒ} is defined by x [symbol] x and x⁻¹ [symbol] xⁿ⁻¹, meaning that a simple “degree shift” may be applied to any negative powers in a Laurent polynomial argument to compute η_{ƒ}.

Proposition 2. Let ƒ(x)=x·g(x)+ƒ(0)∈ [symbol] ₐ[x] such that ƒ(0) is a unit, and [symbol] , k∈ [symbol] be non-negative. If

$${η}_{f , ( - ℓ , k )} : {{ℤ}_{a} [ {x}^{\pm 1} ]}_{- ℓ}^{k} \to {{ℤ}_{a} [ {x}^{\pm 1} ]}_{0}^{k + ℓ}$$

is defined by x [symbol] x and x⁻¹ [symbol] −g(x)ƒ(0)⁻¹, then α(x)− [symbol] (α(x))=0 mod ƒ(x) for all α∈

$${{ℤ}_{a} [ {x}^{\pm 1} ]}_{- ℓ}^{k} .$$

Proof. Let

$$α = {a}_{- ℓ} {x}^{- ℓ} + … + {a}_{- 2} {x}^{- 2} + {a}_{- 1} {x}^{- 1} + {a}_{0} + … + {a}_{k} {x}^{k} ∈ {{ℤ}_{a} [ {x}^{\pm 1} ]}_{- ℓ}^{k} .$$

Since the context is clear, we will write η in place of

[symbol]

By definition,

$$η ( α ) = {\sum }_{i = 1}^{ℓ} {{a}_{- i} ( - 1 )}^{i} {g ( x )}^{i} {f ( 0 )}^{- i} + {\sum }_{i = 0}^{k} {a}_{i} {x}^{i} .$$

It follows that

$$\begin{matrix}α - η ( α ) = {\sum }_{i = 1}^{ℓ} {a}_{- i} {x}^{- i} - {\sum }_{i = 1}^{ℓ} {{a}_{- i} ( - 1 )}^{i} {g ( x )}^{i} {f ( 0 )}^{- i} \\ = {\sum }_{i = 1}^{ℓ} {a}_{- i} ( {x}^{- i} - {( - 1 )}^{i} {g ( x )}^{i} {f ( 0 )}^{- i} )\end{matrix} \qquad ( 2 )$$

We claim that for all i≥1 there exists βᵢ∈ [symbol] ₐ[x^{±1}] such that x⁻ⁱ−ƒ(x)βᵢ(x)=(−g(x)ƒ(0)⁻¹)ⁱ. Proceeding inductively, observe that ƒ(x)=x·g(x)+ƒ(0)⇒x⁻¹−ƒ(x)(x⁻¹ƒ(0)⁻¹)=−g(x)ƒ(0)⁻¹. So β₁(x)=ƒ(0)⁻¹x⁻¹. Now, suppose that for some j≥1 there is βᵢ∈ [symbol] ₐ[x^{±1}] such that x^{-j}−ƒ(x) βⱼ(x)=(−g(x)ƒ(0)⁻¹)^{j}. It follows that

$$\begin{matrix}{( - g ( x ) {f ( 0 )}^{- 1} )}^{j + 1} = {( - g ( x ) {f ( 0 )}^{- 1} )}^{j} ( - g ( x ) {f ( 0 )}^{- 1} ) \\ = ( {x}^{- j} - f ( x ) {β}_{j} ( x ) ) ( {x}^{- 1} - f ( x ) {β}_{1} ( x ) ) \\ = {x}^{- ( j + 1 )} - f ( x ) {x}^{- 1} {β}_{j} ( x ) - \\ f ( x ) {x}^{- j} {β}_{1} ( x ) + {f ( x )}^{2} {β}_{j} ( x ) {β}_{1} ( x ) \\ = {x}^{- ( j + 1 )} - f ( x ) ( {x}^{- 1} {β}_{j} ( x ) - \\ {x}^{- j} {β}_{1} ( x ) + f ( x ) {β}_{j} ( x ) {β}_{1} ( x ) )\end{matrix}$$

So βⱼ₊₁(x)=x⁻¹βⱼ(x)−x^{j}β₁(x)+ƒ(x)βⱼ(x)β₁(x). This proves the claim. Notice that the claim can be rewritten as ƒ(x)βᵢ(x)=x⁻ⁱ−(−1)ⁱg(x)ⁱƒ(0)⁻ⁱ. Substituting this into Equation (2), we get

$$α - η ( α ) = {\sum }_{i = 1}^{ℓ} {a}_{- i} ( {x}^{- i} - {( - 1 )}^{i} {g ( x )}^{i} {f ( 0 )}^{- i} ) = {\sum }_{i = 1}^{ℓ} {a}_{- i} f ( x ) {β}_{i} ( x ) = 0 mod f ( x ) .$$

This completes the proof of the proposition.

Lemma 2. The set

$${{ℤ}_{a} [ {x}^{\pm 1} ]}_{- ℓ}^{k}$$

is a complete set or cuset representatives of Lₐ=L/aL as long as deg ƒ=k+ [symbol] +1.

Proof. Observe that for any two α, β∈

$${{ℤ}_{a} [ {x}^{\pm 1} ]}_{- ℓ}^{k} ,$$

α≠β mod ƒ. it now suffices to recall that

$${η}_{f , ( - ℓ , k )} : {{ℤ}_{a} [ {x}^{\pm 1} ]}_{- ℓ}^{k} \to {{ℤ}_{a} [ {x}^{\pm 1} ]}_{0}^{k + ℓ}$$

is a free module isomorphism and

$${{ℤ}_{a} [ {x}^{\pm 1} ]}_{0}^{k + ℓ}$$

is a complete set of coset representatives for Rₐ when deg ƒ=k+ [symbol] +1.

Corollary 1.

$$η = {η}_{f , ( - ℓ , k )} : {{ℤ}_{a} [ {x}^{\pm 1} ]}_{- ℓ}^{k} \to {{ℤ}_{a} [ {x}^{\pm 1} ]}_{0}^{k + ℓ}$$

induces the identity homomorphism on Lₐ. That is, the mapping Lₐ→Lₐ defined by α+ƒ [symbol] ₐ [symbol] η(α)+ƒ [symbol] ₐ is the identity homomorphism.

The following example illustrates Corollary 1.

### Example 2

Using the polynomial ƒ(x)=1+x+x²−x³+x⁴ from Example 1, along with [symbol] =3, k=0, and a=3, we have

$$η : {{ℤ}_{3} [ {x}^{\pm 1} ]}_{- 3}^{0} \to {{ℤ}_{3} [ {x}^{\pm 1} ]}_{0}^{3} .$$

Let p∈L₃= [symbol] ₃[x^{±1}]/ƒ [symbol] ₃[x^{±1}]. By Lemma 2,

$${{ℤ}_{3} [ {x}^{\pm 1} ]}_{- 3}^{0}$$

is a complete set of coset representatives for L₃, so we can let p(x)∈

$${{ℤ}_{3} [ {x}^{\pm 1} ]}_{- 3}^{0} .$$

Say p(x)=x⁻³+x⁻²−x⁻¹+1. Now, using the encoding matrix of Example 1, we have

$$\begin{matrix}η ( p ) - p = 1 + x + {x}^{2} - {x}^{3} - ( {x}^{- 3} + {x}^{- 2} - {x}^{- 1} + 1 ) \\ = - {x}^{3} - {x}^{2} + {x}^{- 1} + x + {x}^{2} - {x}^{3} \\ = ( - {x}^{3} - {x}^{1} ) f ( x ) + 3 ( - 1 - x + {x}^{3} ) \\ = 0 mod f ( x ) , since coefficients of f are from {ℤ}_{3}\end{matrix} .$$

In particular, this shows that p+ƒ [symbol] ₃[x^{±1}]=η(p)+ƒ [symbol] ₃[x^{±1}].

We now define a version of the Learning With Errors (LWE) problem over the Laurent polynomial ring modulo the principal ideal generated by ƒ and show that it is at least as hard as its PLWE counterpart.

### Definition 2 (Decisional Laurent LWE or Decisional LLWE)

For all κ∈ [symbol] , let ƒ(x)=ƒ_{κ}(x) be a polynomial of degree n=n(κ), and let q=q(κ) be a prime integer such that ƒ(0) is invertible modulo q. Let L= [symbol] [x^{±1}]/ƒ [symbol] [x^{±1}], L_{q}=L/qL, and X denote a distribution over R. For non-negative integers [symbol] , k such that deg ƒ= [symbol] +k+1, take the coset representatives of L to be

$${ℤ [ {x}^{\pm 1} ]}_{- ℓ}^{k} .$$

The decisional-LL WE problem

$${LLWE}_{f , q , 𝒳}^{( - ℓ , k )}$$

states that for any m=poly(κ) it holds that

{(aᵢ,aᵢ·S+eᵢ)}_{i∈[m]} is computationally indistinguishable from {(aᵢ,uᵢ)}_{i∈[m]}

where S is sampled from the distribution X, the aᵢ are uniform in R_{q}, the error polynomials eᵢ are sampled from X, and the ring elements uᵢ are uniformly random over R_{q}.

Theorem 1. If one can solve the

$${LLWE}_{f , q , 𝒳}^{( - ℓ , k )}$$

problem with the polynomial ƒ such that ƒ(0)∈ [symbol] _{q} is a unit, then one can solve the PLWE_{ƒ,q,X} problem with the same polynomial ƒ, x=η(X), and s=η(S).

Proof. We will use the following pair of mappings:

$$\begin{matrix}γ : {R}_{q} \to {L}_{q} is defined by α + f {ℜ}_{a} ↦ α + f {ℒ}_{a} , and \\ η = {η}_{f , ( - ℓ , k )} : {{ℤ}_{q} [ {x}^{\pm 1} ]}_{- ℓ}^{k} \to {{ℤ}_{q} [ {x}^{\pm 1} ]}_{0}^{k + ℓ}\end{matrix} \qquad ( 3 )$$

The latter mapping simply switches between sets of coset representatives for L_{q}. Recall that A_{s,X}^{(q)} is the LLWE distribution [symbol] _{S,X}^{(q)}, is the LLWE distribution. We can map the elements (a, [a·s+e]_{q})∈R_{q}×R_{q} to their isomorphic images under γ⁻¹

$$( {γ}^{- 1} ( a ) , {[ {γ}^{- 1} ( a ) \cdot {γ}^{- 1} ( s ) + {γ}^{- 1} ( e ) ]}_{q} ) = ( a , {[ a \cdot s + e ]}_{q} ) ∈ {L}_{q} \times {L}_{q} .$$

γ acts like the identity on coset representatives.

We then use η⁻¹ to switch from coset representatives in

$${{ℤ}_{t} [ {x}^{\pm 1} ]}_{0}^{k + ℓ}$$

to coset representatives in

$${{ℤ}_{q} [ {x}^{\pm 1} ]}_{- ℓ}^{k} .$$

By Corollary 1, we see that η⁻¹(a·s+e)=η⁻¹(a)η⁻¹(s)+η⁻¹(e)=η⁻¹(a)·S+η⁻¹(e). Clearly η⁻¹(a) is uniform in L_{q} and, since x=η(X), there is e′←X such that e′=η⁻¹(e). Consequently, (η⁻¹(a), [η⁻¹(a)·S+η⁻¹(e)]_{q}) is an LLWE instance according to the distribution

$${ℒ}_{S , X}^{( q )} .$$

So, if we can solve the Decisional-LLWE_{d,q,X} problem with x=η(X) and s=η(S), then we can solve the Decisional-PLWE_{d,q,X} problem.
3.2 when is Laurent LWE Hard?

If ƒ=Φ₂ₙ, and x is an appropriate gaussian error distribution over R with mean 0 for which PLWE_{ƒ,q,X} problem is hard, then

$${LLWE}_{f , q , 𝒳}^{( - ℓ , k )}$$

problem is also hard. Inis comes down to the fact that, in this case,

$${η}_{f}^{- 1}$$

(x)=x. We elaborate below.

Proposition 3. If ƒ(x)=xⁿ+1 and x is a spherical discrete gaussian distribution over L with μ=0 and diagonal covariance matrix σ²I, then

$${η}_{f , ( - ℓ , k )}^{- 1} ( x ) = x$$

for all integers [symbol] , k≥0 such that n=k+ [symbol] +1.

Sketch of proof. First observe that for ƒ(x)=xⁿ+1, η_{ƒ} is defined by the correspondences x [symbol] x and x⁻¹ [symbol] −xⁿ⁻¹. This means, depending on the choice of [symbol] , k, that

$${η}_{f}^{- 1}$$

can be viewed as a composition of negacyclic permutations of the coefficient vector of its argument. So for e←x, the set coefficients of

$${η}_{f}^{- 1} ( e )$$

and e are the same up to sign. The covariance matrix of x being σ²I implies that sampling e←x can be done coefficient-wise, sampling each coefficient from a gaussian distribution over [symbol] with mean 0 and variance σ². Since

$${η}_{f}^{- 1} ( e )$$

and e have the same set of coefficients up to sign, the distribution from which each coefficient is selected remains unchanged. Consequently

$${η}_{f}^{- 1} ( x ) = x .$$

### Theorem 2 (Corollary of Proposition 3).

If x is a spherical discrete gaussian distribution over L with mean 0 and diagonal covariance matrix σ² I, then

$${LLWE}_{f , q , 𝒳}^{( - ℓ , k )}$$

is as hard as PLWE_{ƒ,q,X}.

We are unsure whether the LLWE and PLWE problem are actually equivalent, or whether there are polynomials ƒ and distributions x, X with η_{ƒ}(X)=x for which one of PLWE_{ƒ,q,X} and

$${LLWE}_{f , q , 𝒳}^{( - ℓ , k )}$$

is hard while the other is not. For now, we relegate this investigation to future work.

### 4 THE NEW SCHEME: HERATIO

4.1 Encoding rationals

Despite removing much of the machinery required by previous works to encode rationals for HE, HERatio does require some pre-processing—one must compute a bounded base-b expansion of a rational and then replace b by the unknown x to get a Laurent polynomial. We elaborate below on encode/decode and its correctness conditions.
HERatio.Encode(m, b, (− [symbol] ,k)): For a message m∈ [symbol] , compute the base-b expansion of m to obtain

$${\sum }_{- ∞}^{∞} {a}_{i} {b}^{i} ,$$

where the aᵢ∈ [symbol] _{b}. Truncate (if necessary) and replace everywhere b by x to obtain the Laurent polynomial

$$l ( x ) = {\sum }_{i = - ℓ}^{k} {a}_{i} {x}^{i} ∈ {ℤ [ {x}^{\pm 1} ]}_{- ℓ}^{k}$$

satisfying l(b)≈m. Output l(x).
HERatio.Decode(l′(x), b): Output l′(b).

### Example 3

Consider m=625/7, a base b=3, and bounds [symbol] =4 and k=5. To encode m, first expand it using b=3. Note that the coefficients are from [symbol] ₃ whose representatives are {−1, 0, 1}. This results in:

$$625 / 7 = O ( {3}^{- 5} ) + ( - 1 ) {3}^{- 4} + ( - 1 ) {3}^{- 3} + ( 1 ) {3}^{- 1} + ( 1 ) {3}^{2} + ( 1 ) {3}^{4}$$

Truncate using the bounds [symbol] =4 and k=5 to get:

$$625 / 7 \approx - {3}^{- 4} - {3}^{- 3} + {3}^{- 1} + {3}^{2} + {3}^{4}$$

Replacing everywhere the base 3 by x to get a Laurent polynomial, gives the encoding of m:

$$l ( x ) = - {x}^{- 4} - {x}^{- 3} + {x}^{- 1} + {x}^{2} + {x}^{4}$$

Observe that l(3)=7232/81, and |7232/81−625/7|<0.002, so the approximation is quite close.

Correctness of decoding. Let r₁, . . . , rₙ∈ [symbol] and b∈ [symbol] such that the base-b expansion of rᵢ is lᵢ(b) for lᵢ

$$∈ {ℤ [ {x}^{\pm 1} ]}_{- ℓ}^{k} .$$

Let [symbol] be an arithmetic circuit, and l*= [symbol] (l₁, . . . , lₙ) be the evaluation of [symbol] at the lᵢ. Decoding is correct, i.e. l*(b)= [symbol] (l₁(b), . . . , lₙ(b)), provided l* remains in the set

$${ℤ [ {x}^{\pm 1} ]}_{- ℓ}^{k} .$$

An additional restriction must be imposed for correctness when the encoder is used with HERatio. This is because the plaintext space is a ring of Laurent polynomials whose coefficients come from the ring [symbol] ₜ. The restriction is that computing the Laurent polynomial l* above must not result coefficient overflow modulo t. This requires one to choose b≤t with b and t sufficiently far apart so that the desired circuits can be evaluated.

### 4.2 HERatio

Let

$$L = ℤ [ {x}^{\pm 1} ] / {Φ}_{2 n} ℤ [ {x}^{\pm 1} ] ,$$

and for a∈ [symbol] let Lₐ=L/aL. The plaintext space is the ring Lₜ, for t≥2, and the ciphertext space is product ring L_{q}×L_{q} for q>>t. The coset representatives of the elements of L are

$${ℤ [ {x}^{\pm 1} ]}_{- ℓ}^{k} ,$$

where [symbol] , k are nonnegative integers satisfying k+ [symbol] +1=n. We let λ be the security parameter and X be a discrete Gaussian distribution for which

$${LLWE}_{f , q , 𝒳}^{( - ℓ , k )}$$

is nard (see Theorem 2). HERatio is obtained from BFV by replacing everywhere R by L, Rₜ by Lₜ, and R_{q}×R_{q} by L_{q}×L_{q}.
HERatio.SecretKeyGen: Sample s∈L with coefficients uniformly distributed in {−1, 0, 1}. Note, the ability to sample from this set while maintaining security is inherited from BFV.
Output

$$sk = s$$

HERatio.PublicKeyGen(sk): Let s=sk. Sample a←L_{q}, and e←X.
Output

$$pk = ( {[ - ( as + e ) ]}_{q} , a ) ∈ {L}_{q} \times {L}_{q}$$

HERatio.EvalKeyGen(sk): For i=0, . . . , [symbol] , where w≥2 and [symbol] =└log w_{q}┘, sample aᵢ←L_{q}, and eᵢ←X. Let

$$evk [ i ] = ( {[ - ( {a}_{i} s + {e}_{i} ) + {w}^{i} {s}^{2} ]}_{q} , {a}_{i} ) ∈ {L}_{q} \times {L}_{q}$$

Output the vector of pairs

$$evk = ( evk [ 0 ] , … , evk [ ℓ ] )$$

HERatio.Enc(pk, [symbol] ∈Lₜ): Let

$$Δ = ⌊ \frac{q}{t} ⌋$$

and pk=(p₀, p₁). Sample u∈L with coefficients uniform in {−1, 0, 1}, and e₀, e₁←x.
Output

$$ct = ( {[ Δℓ + {p}_{0} u + {e}_{0} ]}_{q} , {[ {p}_{1} u + {e}_{1} ]}_{q} ) ∈ {L}_{q} \times {L}_{q}$$

HERatio.Dec(sk, ct∈L_{q}×L_{q}): Let s=sk and ct=(c₀, c₁).
Output

$${{ℓ}^{′} ( X ) = [ ⌊ {\frac{t}{q} [ {c}_{0} + {c}_{1} s ]}_{q} ⌉ ]}_{t} ∈ {L}_{t}$$

HERatio.Add(ct₀, ct₁):
Output

$$( {ct}_{0} [ 0 ] + {ct}_{1} [ 0 ] , {ct}_{0} [ 1 ] + {ct}_{i} [ 1 ] ) ∈ {L}_{q} \times {L}_{q}$$

HERatio.PartialMult(ct₀, ct₁): Denote (c₀, c₁)=ct₀ and (d₀, d₁)=ct₁.
Compute

$${{{{{c}^{′}}_{0} = [ ⌊ \frac{t}{q} {c}_{0} {d}_{0} ⌉ ]}_{q} , {{c}^{′}}_{1} = [ ⌊ \frac{t}{q} ( {c}_{0} {d}_{1} + {c}_{1} {d}_{0} ⌉ ]}_{q} , {{c}^{′}}_{2} = [ ⌊ \frac{t}{q} {c}_{1} {d}_{1} ⌉ ]}_{q} ,$$

Output

$${ct}_{prod} = ( {{c}^{′}}_{0} , {{c}^{′}}_{1} , {{c}^{′}}_{2} ) ∈ {L}_{q} \times {L}_{q} \times {L}_{q}$$

HERatio.Relinearize(ct_{prod}∈L_{q}×L_{q}×L_{q}, evk): Denote (c′₀, c′₁, c′₂)=ct_{prod}. Express c′₂ in base w, so that

$${{c}^{′}}_{2} = {\sum }_{i = 0}^{ℓ} {c}_{2}^{′ ( i )} {w}^{i} .$$

Set

$${c}_{0} = {{c}^{′}}_{0} + {\sum }_{i = 0}^{ℓ} evk [ i ] [ 0 ] {c}_{2}^{′ ( i )} , {c}_{1} = {{c}^{′}}_{1} + {\sum }_{i = 0}^{ℓ} evk [ i ] [ 1 ] {c}_{2}^{′ ( i )} ,$$

Output

$$( {c}_{0} , {c}_{1} ) ∈ {L}_{q} \times {L}_{q}$$

HERatio.Mult(ct₀, ct₁, evk):
Output
   HERatio.Relinearize(HERatio.PartialMult (ct₀, ct₁), evk)

### 4.3 Correctness of HERatio

Fan and Vercauteren analyze noise growth and derive correctness conditions for BFV using the polynomial infinity norm ∥⋅∥_{∞}. Since this norm is defined coefficient-wise, switching from “classic” to Laurent polynomials does not change their analysis. This means that HERatio inherits the correctness conditions from at least lemma 1 and theorem 1.

### 5 COMPARISON WITH BFV

Since HERatio is obtained from BFV by simply swapping the ring of polynomials [symbol] [x]/ϕ₂ₙ [symbol] [x] for the ring of Laurent polynomials [symbol] [x^{±1}]/Φ₂ₙ [symbol] [x^{±1}], we expect the performance of the two schemes to be very similar. With this in mind, we compare separately the encodings which allow HERatio and BFV, respectively, to work with rational numbers. The encoding used for BFV is that of Equation (1), and the encoding for HERatio is detailed in Section 4.1. We emphasize that the purpose of our implementations is to show that HERatio and BFV have similar performance when implemented the same way.

### 5.1 Implementation

We divided our results into 4 distinct groups, namely Codec Operations (encoding and decoding), Key Generation, Ciphertext Generation, and Homomorphic Operations, although some of them show dependent relationships. We measured the average time execution and memory used on each operation in order to analyze comparatively both HERatio and BFV schemes, along with their respective codecs HERatio.Encode, HERatio.Decode, and the rational encoder and decoder.

We chose messages m₀=12345.678 and m₁=947.1273, the additive scalar sₐ=4, and multiplicative scalar sₘ=42.122 to perform all calculations. The variables were initially defined either as 64-bits float numbers or 64-bits integers. However, during the execution these inputs were converted into arbitrary-size numbers to preserve correctness. For comparison purposes, we used the same parameters for HERatio and BFV, these are polynomials of length 32, with q=9, 876, 523, 525, t=2, 131, σ=3.19, 10 as the expansion base, and w=128 for the relinearization base for both BFV and HERatio.

The experiments were implemented with the Golang programming language version 1. 19, on a MacBook Pro 15-inch, MacOS Monterey 12. 7. 1, 2.7 GHZ Quad-Core Intel (R) Core (TM) i7, 16 GB 2133 MHz LPDDR3, 500 GB SSD. Each operation was analyzed by evaluating the mean of 1, 000 executions, where the runtime and memory allocated were measured. Note that our implementation of BFV did not include any optimizations, though any existing optimization of BFV could be translated to an equivalent optimization of HERatio.

### Codec Operations.

For Codec operations, we measured the performance of encoding a message m₀ as c₀ through both codecs, such that c₀=Encode(m₀). Furthermore, we also executed the reverse operation to recover the original message from code c₀, such that m′₀=Decode(c₀).

TABLE 1
Codec Results.

| | Avg. Time (ms) | | | Memory (MB) | |
|---|---|---|---|---|---|
| Operation | BFV | HERatio | | BFV | HERatio |
| Encoding | 0.0619 | 0.0567 | +8.40% | 0.0227 | 0.0223 |
| Decoding | 0.0270 | 0.0245 | +1.76% | 0.0096 | 0.0083 |

The HERatio codec was 0.0567 ms faster for encoding a message, and 0.0025 ms faster for decoding.

### Key Generation.

The key generation analysis measured the functions SecretKeyGen, PublicKeyGen, and EvalKeyGen, where all procedures used the same pseudo-random source. The sk=SecretKeyGen( ) function is equivalent for both schemes, whereas pk=PublicKeyGen(sk), and evk=EvalKeyGen(sk) differ in their internal polynomial multiplication.

TABLE 2
Operation Results.

| | Avg. Time (ms) | | | Memory (MB) | |
|---|---|---|---|---|---|
| Operation | BFV | HERatio | | BFV | HERatio |
| Secret Key | 0.1066 | 0.1139 | −6.40% | 0.0324 | 0.0344 |
| Public Key | 5.9967 | 5.9625 | +0.57% | 3.2840 | 3.3453 |
| Evaluation Key | 56.2224 | 55.4312 | +1.40% | 29.2504 | 28.0354 |
| Encryption | 0.5886 | 0.5940 | −0.90% | 0.2867 | 0.2900 |
| Decryption | 0.3501 | 0.3402 | +2.82% | 0.1733 | 0.1756 |
| Scalar Addition | 0.0669 | 0.0719 | −6.95% | 0.0324 | 0.0344 |
| Ciphertext Addition | 0.1608 | 0.1598 | +0.62% | 0.0740 | 0.0767 |
| Scalar Multiplication | 0.1592 | 0.1551 | +2.57% | 0.0759 | 0.0744 |
| Ciphertext | 3.1545 | 3.2326 | −2.41% | 1.6593 | 1.6857 |
| Multiplication | | | | | |

HERatio and BFV had a differential of 0.0073 milliseconds (ms) for the secret key generation, a negligible difference that can be used as a threshold for comparison since the implementation of both functions are nearly equal. For public key generation HERatio was 0.0342 ms faster, and 0.7912 ms ahead for evaluation key.

Ciphertext Generation. On cipher functions we had a small difference, where HERatio encrypted code c₀ as ct₀=Encrypt(pk, c₀) 0.0054 ms slower than BFV, and decrypted the same ciphertext as c′₀=Decrypt(sk, ct₀) 0.0099 faster.

When we consider the difference between equivalent operations for both schemes, such as SecretKeyGen, we notice that the generation of ciphertexts have a negligible margin.

### Homomorphic Operations.

We homomorphically tested additive and multiplicative operations (Table 2) between ciphertexts (i.e., ct₀ and ct₁) and additive (i.e., sₐ) and multiplicative scalars (i.e., sₘ).

HERatio executed the ciphertext addition and scalar multiplication, respectively,

0.001 ms and 0.004 ms faster than BFV, whereas the scalar addition and ciphertext multiplication were 0.005 ms and 0.0781 ms slower. The memory usage did not increase in a rate that was relevant for the experiment.

### 6 CONCLUSION

We have presented a new variant of the LWE problem based on Laurent polynomials, and constructed a new variant of the BFV scheme based on this problem. The plaintext space of our scheme, HERatio, is a set of Laurent polynomials with exponents ranging from − [symbol] to k. The exponent range can be chosen to suit the goal application, and does not affect the hardness of the new LWE variant. The main appeal of HERatio is that it can work with rationals via their bounded base-b expansions—all one must do is replace b by the unknown x. While enjoying efficiency comparable to BFV, HERatio is more mathematically streamlined than prior art, and also mitigates the difficulty in choosing parameters to make sure a rational encoding “plays well” with the underlying HE scheme.

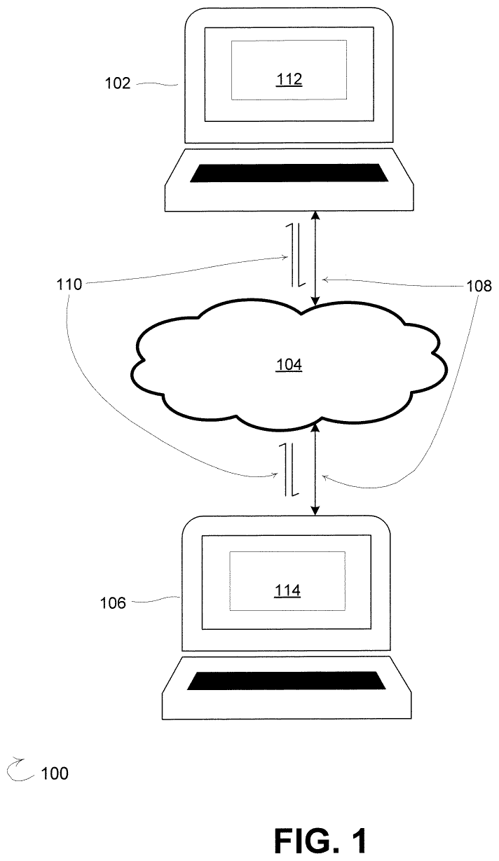

### Hardware Implementation for an Embodiment (FIG. 1)

FIG. 1 is a block diagram 100 of the hardware implementation for an embodiment. A source computing device 102 is connected over an electronic network/bus connection 108 to an intermediary computing device 104 and a destination device 106. Likewise, the intermediary computing device 104 and destination computing device 106 are, in turn, connected to each other 104, 106 as well as to the source computing device 102 over the electronic network/bus connection 108. The intermediary computing device 104 is optional and if the intermediary computing device 104 is not present, the source computing device 102 is connected over the electronic network/bus connection 108 to the destination computing device 106.

In the embodiment shown in FIG. 1, the source computing device 102 acts as the source of the encrypted data 110 and the source computing device 102 sends the encrypted data 110 over the network/bus connection 108 to the intermediary computing device 104 and/or the destination computing device 106. When the intermediary computing device 104 receives the encrypted data 110 from the source computing device 102, the intermediary computing device 104 may perform homomorphic arithmetic operations (addition, subtraction, and/or multiplication) with at least one additional ciphertext to obtain a result ciphertext 110 that the intermediary computing device 104 may then send over the network/bus connection 108 to the destination computing device 106. The destination computing device 106 may decrypt the received encrypted ciphertext(s) 110 to obtain unencrypted data reflecting either the original integer data value(s) if the ciphertext(s) 110 was the original ciphertext(s) sent by the source computing device 102 or an unencrypted result(s) of the arithmetic operations performed by the intermediary computing device 104 if the received ciphertext(s) 110 is a result ciphertext(s) sent by the intermediary computing device 104 after performing homomorphic arithmetic operations with the original ciphertext(s) and at least one additional ciphertext. The destination device 104 generally acts as a final destination for the encrypted data 110 received from the network/bus connection 106 intended for decryption.

The encrypted data 110 starts at the source computing device as one or more rational numbers. An embodiment at the source 102 encrypts the rational number with the encryption portion of a BFV system 114 running on the source computing device 102, where the BFV system 114 of an embodiment is modified such that the classical polynomial rings of a classical BFV encryption system are replace by Laurent polynomial rings. The original or result ciphertext(s) 110 received at the destination device 106 is decrypted by the Decryption portion of the FHE system 114 running on the destination computing device 106 into the corresponding rational numbers to obtain the ultimate desired values, be that the original rational value sent by the source computing device 102 or the resultant value from homomorphic operations sent from the intermediary computing device 104.

Generally, communications, including concealed/encrypted communications, are bi-directional such that the source 102, intermediary 104, and destination 106 computing devices may change roles as the encrypted data 110 source 102, intermediary 104, and the encrypted data 110 destination 106 as is necessary to accommodate the transfer of data back and forth between the computing devices 102, 104, 106. Notably, the intermediary computing device 104 does not require knowledge of the secret keys to perform the homomorphic arithmetic operations, so it is likely that the intermediary computing device 104 will be at least computationally isolated from the source 102 and destination 106 computing devices. Additionally, while the computing devices 102, 104, 106 are depicted as separate devices in FIG. 1, the functionality of the source computing device 102, the intermediary 104 and the destination device 106 may be shared on a single computing system/device or among two or more computing devices as it is often desirable to conceal data when transferring data between components of a single device.

Further, as shown in FIG. 1, the source 102 and destination 106 computing devices appear to be laptop computers and the intermediary computing device appears as a “cloud” that may represent one or several devices connected on the network 108 performing homomorphic arithmetic computations without a need to decrypt to the data 110 to obtain the correct decrypted value for the arithmetic operations. Generally, any computing device capable of communication over any form of electronic network or bus communication platform 106 may be one or more of the source 102, the intermediary 104, and destination 106 computing devices. Additionally, the source 102, intermediary 104 and/or destination 106 computing devices may actually be the same physical computing device communicating over an internal bus connection 108 with itself, but still desiring to encrypt transferred data to ensure that an attacker cannot monitor the internal communications bus 108 to obtain sensitive data communications in an unencrypted format.

Various embodiments may implement the network/bus communications channel 108 using any communications channel 108 capable of transferring electronic data between the source 102, intermediary 104, and destination 106 computing devices. For instance, the network/bus communication connection 108 may be an Internet connection routed over one or more different communications channels during transmission between the source 102, intermediary 104, and destination 106 devices. Likewise, the network/bus communication connection 108 may be an internal communications bus of a computing device, or even the internal bus of a processing or memory storage Integrated Circuit (IC) chip, such as a memory chip or a Central Processing Unit (CPU) chip. The network/bus communication channel 108 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the source 102, intermediary 104, and/or destination 106 computing devices. The source 102, intermediary 104, and/or destination 106 computing devices may each be a computer or computer system, or any other electronic devices capable of performing the communications and computations of an embodiment. The source 102, intermediary 104, and/or destination 106 devices may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASIC), and/or a Field Programmable Gate Array (FPGA). Notably, the first 102, second 104, and/or third 106 computing devices may be the storage controller of a data storage media (e.g., the controller for a hard disk drive) such that data delivered to/from the data storage media is always encrypted so as to limit the ability of an attacker to ever have access to unencrypted data. Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

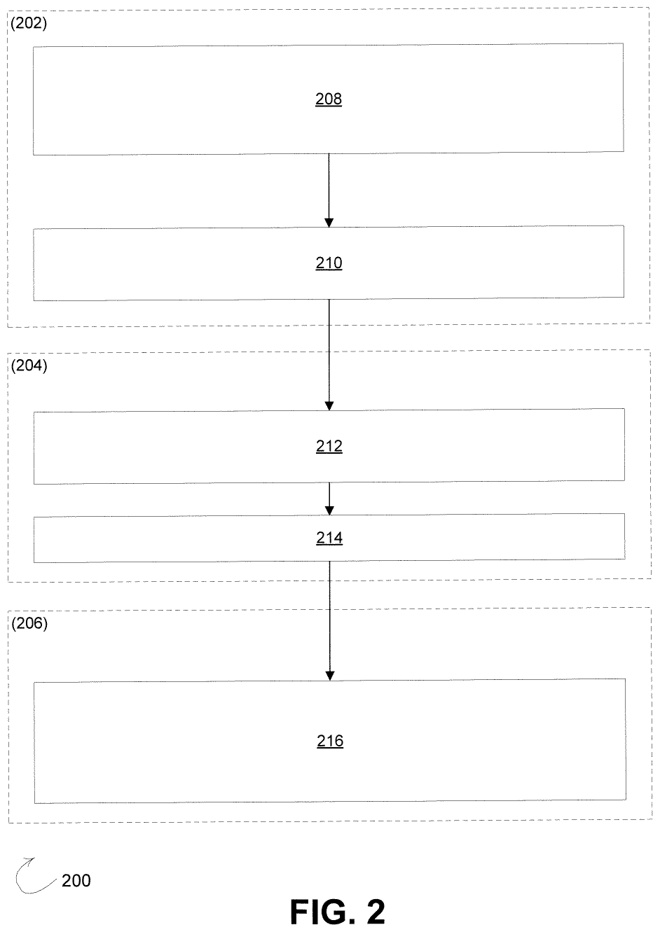

### Operational Flow Chart for an Embodiment (FIG. 2)

FIG. 2 is a flow chart 200 of operations for an embodiment. At process 208, the source computing device 202 encrypts a rational number into a ciphertext using a BFV encryption system running on the source computing device 202 that is modified such that the classical polynomial rings of the BFE encryption system are replaced by Laurent polynomial rings. In mathematical terms this replacement may be expressed as the classical polynomial rings in BFV homomorphic encryption represented as [symbol] [x]/Φ₂ₙ [symbol] [x] being replaced by Laurent polynomial rings represented as [symbol] [x^{±1}]/Φ₂ₙ [symbol] [x^{±1}]. The replacement of the classical polynomial rings of the BFV encryption system with Laurent polynomial rings removes the need to encode/decode the rational numbers for encryption/decryption, saving operation time and complexity. That said, pre-processing for the encryption does include computing a bounded base-b expansion of the rational number and replacing b by unknown variable x. At process 210, the source computing device 202 sends the at least one ciphertext to the destination computing device 206 if no homomorphic calculations are desired, or to the intermediary computing device 204 if homomorphic calculations are desired.

The processes 212-214 of the intermediary computing device 204 are not necessary if it is not desired to perform homomorphic calculations with at least one additional ciphertext to obtain a result ciphertext, in which case the original ciphertext may simply be sent to the destination computing device 206 for decryption from the source computing device 202. Assuming homomorphic calculation operations are desired, at process 212, the intermediary computing device 204 homomorphically computes at least one arithmetic function with the at least one ciphertext and at least one additional ciphertext, obtaining at least one result ciphertext. The potential arithmetic functions are one or more of addition, subtraction, and multiplication. Notably, the intermediary computing device 204 does not have knowledge to be able to decrypt any ciphertext meaning the arithmetic functions performed in process 212 at the intermediary computing device 204 are performed homomorphically with encrypted data. Process 212 performs the necessary operations to perform homomorphic calculations on encrypted data. At process 214, the intermediary computing device 204 sends the at least one result ciphertext to the destination computing device 206.

At process 216, the destination computing device 206 decrypts the ciphertext or the result ciphertext into the original rational number or the resultant rational number if homomorphic arithmetic operations were performed on the intermediary computing device 204.

Additionally, while the flow charts and flow chart details described above with respect to FIG. 2 describe a methodology that may be embodied as a method or process, another embodiment may be recognized as a computer system, and/or as an intermediary computing device that stores and/or performs homomorphic operations of encrypted data by implementing the processes described above with respect to the flow chart and flow chart details of FIG. 2. Further, in describing the computing system, and/or the intermediary computing system, one, or more, individual processes described above for the methodology may be broken down and represented as a subsystem of the overall encryption computer system. A subsystem of the computer system, in whole or in part, may be assigned to a particular hardware implemented system, such as a dedicated Application Specific Integrated Circuit (ASIC) or Field Programmable Gate Array (FPGA). One or more subsystems, in whole or in part, may alternatively be implemented as software or firmware instructions defining the operation of a computer system with specific regard to the one or more subsystems implemented as software or firmware instructions. The software or firmware instructions may cause the Central Processing Unit, memory, and/or other systems of a computer system to operate in particular accordance with the particular one or more subsystems designated features.

The foregoing description of the invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated.

What is claimed is:

1. A method for Homomorphic Encryption (HE) of Rational data (HERatio) built upon Brakerski, Fan, and Vercauteren (BFV) homomorphic encryption for homomorphic encrypted data transmission between a source computing device and a destination computing device, the method comprising:
encrypting by said source computing device at least one rational number into a corresponding at least one ciphertext using an instance of a modified BFV homomorphic encryption operating on said source computing device wherein said modified BFV homomorphic encryption is modified such that classical polynomial rings in BFV homomorphic encryption are replaced by Laurent polynomial rings;
sending by said source computing device said at least one ciphertext to said destination computing device;
decrypting by said destination computing device said at least one ciphertext into said at least one rational number using an instance of said modified BFV homomorphic encryption having said classical polynomial rings in said BFV homomorphic encryption replaced by said Laurent polynomial rings operating on said destination computing device.

2. The method of claim 1 wherein said classical polynomial rings in BFV homomorphic encryption are represented as [symbol] [x]/Φ₂ₙ [symbol] [x] and said Laurent polynomial rings are represented as [symbol] [x^{±1}]/Φ₂ₙ [symbol] [x^{±1}].

3. The method of claim 1 wherein computation of said Laurent polynomial rings includes computing a bounded base-b expansion of said at least one rational number and replacing b by unknown variable x.

4. The method of claim 1:
wherein said process of sending by said source computing device said at least one ciphertext to said destination computing device instead sends said at least one ciphertext to an intermediary computing device;
wherein the method of claim 1 further comprises:
homomorphically computing by said intermediary computing device at least one arithmetic function with said at least one ciphertext and at least one additional ciphertext to obtain at least one result ciphertext; and
sending by said intermediary computing device said at least one result ciphertext in place of said at least one ciphertext to said destination computing device;
wherein said process of decrypting by said destination computing device said at least one ciphertext into said at least one rational number instead decrypts said at least one result ciphertext into at least one result rational number such that said at least one result rational number equals an unencrypted computation of said arithmetic functions of unencrypted forms of said at least one ciphertext and said at least one additional ciphertext.

5. The method of claim 4 wherein said at least one arithmetic function is at least one of a group of arithmetic functions chosen from: addition, subtraction, and multiplication.

6. A HERatio system that provides Homomorphic Encryption (HE) of Rational data that is built upon Brakerski, Fan, and Vercauteren (BFV) homomorphic encryption for homomorphic encrypted data transmission between a source computing device and a destination computing device, the HERatio system comprising:
said source computing device, wherein said source device further comprises:
a HERatio encryption subsystem that encrypts at least one rational number into a corresponding at least one ciphertext using a modified BFV homomorphic encryption scheme wherein said modified BFV homomorphic encryption is modified such that classical polynomial rings in BFV homomorphic encryption are replaced by Laurent polynomial rings; and
a ciphertext send subsystem that sends said at least one ciphertext to said destination computing device; and
said destination computing device, wherein said destination computing device further comprises:
a HERatio decryption subsystem that decrypts said at least one ciphertext into said at least one rational number using said modified BFV homomorphic encryption that has said classical polynomial rings in said BFV homomorphic encryption scheme replaced by said Laurent polynomial rings.

7. The HERatio system of claim 6 wherein said classical polynomial rings in BFV homomorphic encryption are represented as [symbol] [x]/Φ₂ₙ [symbol] [x] and said Laurent polynomial rings are represented as [symbol] [x^{±1}]/Φ₂ₙ [symbol] [x^{±1}].

8. The HERatio system of claim 6 wherein computation of said Laurent polynomial rings includes computing a bounded base-b expansion of said at least one rational number and replacing b by unknown variable x.

9. The HERatio system of claim 6:
wherein said ciphertext send subsystem that sends said at least one ciphertext to said destination computing device instead sends said at least one ciphertext to an intermediary computing device;
said intermediary computing device, wherein said intermediary computing device further comprises:
a homomorphic computation subsystem that homomorphically computes at least one arithmetic function with said at least one ciphertext and at least one additional ciphertext to obtain at least one result ciphertext; and
an intermediary ciphertext send subsystem that sends said at least one result ciphertext in place of said at least one ciphertext to said destination computing device;
wherein said HERatio decryption subsystem operating on said destination computing device that decrypts said at least one ciphertext into said at least one rational number instead decrypts said at least one result ciphertext into at least one result rational.

10. The HERatio system of claim 9 wherein said at least one arithmetic function is at least one of a group of arithmetic functions chosen from: addition, subtraction, and multiplication.
